(19) United States
(12) Patent Application Publication
(10) Pub. No.: US 2025/0304454 A1
(43) Pub. Date: Oct. 2, 2025

(54) METHOD FOR PREPARING ZIRCONIUM BORIDE THROUGH ELECTRIC SMELTING

(71) Applicant: Zhengzhou Zhenzhong Fused New Material Co., Ltd., Zhengzhou City (CN)

(72) Inventors: Xinmeng YU, Zhengzhou City (CN); Qisheng LI, Zhengzhou City (CN); Jiangying LI, Zhengzhou City (CN); Qun LI, Zhengzhou City (CN)

(73) Assignee: Zhengzhou Zhenzhong Fused New Material Co., Ltd., Zhengzhou City, HA (CN)

(21) Appl. No.: 19/051,117

(22) Filed: Feb. 11, 2025

(30) Foreign Application Priority Data
Apr. 2, 2024 (CN) 202410393885.X

(51) Int. Cl. C01B 35/04; F27B 3/08; H05B 7/18

(52) U.S. Cl. CPC C01B 35/04; F27B 3/085; H05B 7/18; C01P 2002/72; F27M 2003/13

(57) ABSTRACT

Provided is a method for preparing zirconium boride through electric smelting. The method includes: mixing a zirconium source, boric anhydride, and a carbon source to obtain a furnace charge; conducting a smelting by feeding the furnace charge into a three-phase electric arc furnace and melting, subjecting a resulting material to refinement, heat preservation, and homogenization in sequence; heat preserving a resulting product for 1 hour to 2 hours after the smelting, and turning off the three-phase electric arc furnace; removing a resulting furnace shell and natural cooling a resulting melt; and crushing the resulting melt, selecting and removing a material skin; crushing a resulting selected material and selecting again, and removing a loose lump and collecting a dense lumpy material; and crushing the dense lumpy material, and then testing to qualify as a finished product.

### CROSS REFERENCE TO RELATED APPLICATION

This patent application claims the benefit and priority of Chinese Patent Application No. 202410393885.X filed with the China National Intellectual Property Administration on Apr. 2, 2024, the disclosure of which is incorporated by reference herein in its entirety as part of the present application.

### TECHNICAL FIELD

The present disclosure relates to the technical field of inorganic non-metallic materials, and in particular to a method for preparing zirconium boride through electric smelting.

### BACKGROUND OF THE INVENTION

Zirconium boride is a chemical substance belonging to borides, with the molecular formula of ZrB₂. Zirconium boride is a grey hard crystal in terms of physical properties. Zirconium boride has three compositions, namely zirconium monoboride, zirconium diboride, and zirconium triboride, of which only zirconium diboride is stable in a wide temperature range. Industrial production is mainly based on zirconium diboride. Zirconium diboride has a hexagonal crystal structure, appearing as a gray crystal or powder, with a relative density of 5.8 and a melting point of 3,040° C. Zirconium diboride is resistant to high temperatures, and has high strength at both room temperature and high temperatures. Zirconium diboride also shows good thermal shock resistance, low electric resistance, oxidation resistance at high temperatures, with a metallic luster.

Zirconium boride can be used as a high-temperature-resistant aerospace material, a smooth and wear-resistant solid material, a cutting tool, a thermocouple protection tube for temperature difference, and an electrode material for electrolyzing molten compounds, and is also suitable for use on the surface of rolling bearing balls. With good performance such as low density, high melting point, high hardness, high specific strength, high specific stiffness, good thermal conductivity, excellent electrical conductivity, excellent ablation resistance, and good oxidation resistance, zirconium boride powder is considered one of the most promising integrated structural and functional materials, and has been widely used in aerospace, military industry manufacture, mineral metallurgy, machining, and other fields.

Principally, there are four methods for preparing zirconium boride: (1) direct reaction of zirconium metal and boron; (2) boron carbide method; (3) carbon reduction method; and (4) vapor deposition method. The commercial synthesis of zirconium boride mainly adopts (2) and (3), with the reaction equation shown in formula (1):

3ZrO₂+B₄C+8C+B₂O₃═3ZrB₂+9CO↑ (1).

In the prior art, the materials used in the preparation method are complex, and the raw material used is zirconium metal or B₄C that is expensive. The production process is complex.

### SUMMARY OF THE INVENTION

In view of this, the present disclosure provides a method for preparing zirconium boride through electric smelting, in which a zirconium source, boric anhydride, and a carbon source are used raw materials, which are easy to obtain; a simple electric arc furnace melting process is adopted and zirconium boride products are produced through high-temperature chemical reactions in an electric arc furnace, thus reducing the production cost of zirconium boride products.

In some embodiments of the disclosure, a monoclinic zirconium oxide (a desilicated zirconium, a natural baddeleyite or a chemical zirconiuma) with an amount of ZrO₂ plus HfO₂ of greater than 99% is used as a main raw material, and boric anhydride or boric acid (which becomes boric anhydride after anhydration) as well as carbon black, or a graphite powder, a petroleum coke powder are used as auxiliary raw materials. The raw materials are uniformly mixed in a certain ratio to prepare a mixed material, and then the mixed material is fed into an electric arc furnace, and a high-temperature electric smelting and a high-temperature chemical reaction are conducted to obtain a zirconium boride with a metallic luster, and the reaction equation is shown in formula (2):

ZrO₂+B₂O₃+5C═ZrB₂+5CO↑ (2).

The present disclosure provides a method for preparing zirconium boride through electric smelting, including the following steps:
step 1: mixing a zirconium source, boric anhydride, and a carbon source in a parts-by-weight ratio of 50:28-32:24-28 to obtain a furnace charge;
step 2: conducting a smelting by feeding the furnace charge into a three-phase electric arc furnace and melting, subjecting a resulting material to refinement, heat preservation, and homogenization, and then repeating these processes a plurality of times until the three-phase electric arc furnace is full; in a specific embodiment, the furnace charge is fed into the three-phase electric arc furnace in batches according to a melting speed of the furnace charge, and a height of an electrode increases as a level of a material surface in the three-phase electric arc furnace rises, and then the melting, the refinement, and the heat preservation are performed;
step 3: heat preserving a resulting product for 1 h to 2 h after the smelting, and turning off the three-phase electric arc furnace; and after the three-phase electric arc furnace is turned off for 12 h, removing a resulting furnace shell and natural cooling a resulting melt; and under a condition that the resulting melt falls to not greater than 100° C., crushing the resulting melt, selecting, and removing a material skin;
step 4: crushing a resulting selected material to a particle size of greater than 0 and not greater than 4 meshes and selecting again, and removing a loose lump and collecting a dense lumpy material; where the dense lumpy material has a metallic luster, and the loose lump has no metallic luster; and
step 5: crushing the dense lumpy material obtained in step 4 and removing iron, and then testing to qualify as a finished product.

In some embodiments, crushing the dense lumpy material is conducted by crushing and processing the dense lumpy material to a particle size required by a user and classifying based on the fact that a material with the particle size in a range of 0 to 4 meshes can be arbitrarily classified to obtain a zirconium boride product with different particle sizes required by different users, or processing the dense lumpy material by using a pulverizer to obtain a zirconium boride powder with different fineness required by the user.

In some embodiments, in step 1, the zirconium source is any one selected from the group consisting of a monoclinic zirconium dioxide, a desilicated zirconium, a natural baddeleyite, and a chemical zirconium; and an amount of ZrO₂ plus HfO₂ in the zirconium source is greater than 99%.

In some embodiments, in step 1, the carbon source is any one selected from the group consisting of carbon black, a graphite powder, and a petroleum coke powder.

In some embodiments, in step 2, the three-phase electric arc furnace is selected from the group consisting of a stationary electric arc furnace and a tilted electric arc furnace.

In some embodiments, under a condition that the three-phase electric arc furnace is the stationary electric arc furnace, a molten state of a mixed material in the three-phase furnace is a melt with a solid outside and a liquid inside; and under a condition that the three-phase electric arc furnace is the tilted electric arc furnace, the molten state of the mixed material in the three-phase furnace is a liquid melt that is poured into a mold to obtain a desired product.

In some embodiments, under the condition that the three-phase electric arc furnace is the stationary electric arc furnace, the mixed material melts into the melt, and since a shell of the stationary electric arc furnace is water-cooled, the melt is solid outside and liquid inside; and under the condition that the three-phase electric arc furnace is the tilted electric arc furnace, the mixed material melts into the liquid melt that is poured into the mold to obtain a product with desired shape; after the liquid melt is completely poured, the three-phase furnace is reset, and the feeding and the melting of the mixed material is continued conducted, and then such procedure is repeated until all the mixed material is melted. The liquid melt is poured into the mold to obtain the product with the desired shape which is a shape that is convenient for breaking up during a breaking, making it more time-saving and effort-saving.

In some embodiments, in step 2, the melting and the refinement are independently performed at a voltage of 120 V to 250 V and a current of 6,000 A to 15,000 A.

In some embodiments, in step 2, the melting and the refinement are independently performed at the voltage of 220 V and the current of 8,000 A to 12,000 A.

In some embodiments, in step 2, a ratio of a time for the melting time to a time for the refinement is 1:2.

In some embodiments, in step 2, the melting and the refinement are independently performed at a temperature of 3,000° C. to 3,300° C.

Compared with the prior art, some embodiments of the present disclosure have the following beneficial effects:

The present disclosure provides a method for preparing zirconium boride through electric smelting. In the present disclosure, a zirconium source, boric anhydride, and a carbon source are used as raw materials, which are easy to obtain. Moreover, a simple electric arc furnace smelting process is adopted and low-cost zirconium boride products are produced through high temperature chemical reactions in an electric arc furnace, thus having strong market competitiveness.

### BRIEF DESCRIPTION OF THE DRAWINGS

FIG. 1 shows a flow chart of the method for preparing zirconium boride through electric smelting according to an embodiment in the present disclosure;

FIG. 2 shows an XRD (X-ray Diffraction) crystalline phase diagram of the zirconium boride prepared in Example 1;

FIG. 3 shows an XRD crystalline phase diagram of the zirconium boride prepared in Example 2;

FIG. 4 shows an XRD crystalline phase diagram of the zirconium boride prepared in Example 3; and

FIG. 5 shows a photograph of the zirconium boride prepared in Example 1.

### DETAILED DESCRIPTION OF THE EMBODIMENTS

The present disclosure will be further described below in conjunction with examples.

### Example 1

A method for preparing zirconium boride through electric smelting was performed as follows:
Step 1: 50 parts by weight of a desilicated zirconium with an amount of ZrO₂ plus HfO₂ of greater than 99%, 29 parts by weight of boric anhydride, and 26 parts by weight of a carbon black powder were fed into a mixer and uniformly mixed to obtain a furnace charge.
Step 2: A smelting was conducted by feeding the furnace charge in batches into a three-phase electric arc furnace and melting, then subjecting a resulting material to refinement, heat preservation, and homogenization in sequence, and then repeating these processes a plurality of times until the three-phase electric arc furnace was full; where the three-phase electric arc furnace was a stationary electric arc furnace or a tilted electric arc furnace; the melting and the refinement each were performed at a voltage of 220 V and a current of 8,000 A to 12,000 A, and a temperature of 3,100° C.; and a ratio of a time for the melting to a time for the refinement was 1:2.
Step 3: After the smelting, the heat preservation was conducted for 2 h, and then the three-phase electric arc furnace was turned off; after turning off for 12 h, a resulting furnace shell was removed and a resulting melt was natural cooled, and under a condition that the resulting melt fell to not greater than 100° C., the resulting melt was crushed, selected and a material skin was removed.
Step 4: A resulting selected material was crushed to not greater than 4 meshes, and then selected again, a loose lump was removed and a dense lump was collected.
Step 5: The dense lumpy material obtained in step 4 was crushed and iron was removed, and then a testing was conducted to qualify as a finished product.

The specific steps are shown in FIG. 1.

In some embodiments of the present disclosure, under a condition that a material is in a molten state, the material is red, and as the temperature of the material decreases, the colour of the material becomes lighter, especially under a condition that the material is naturally cooled to not greater than 200° C., the colour of the material becomes light gray with a metallic luster; and under a condition that a resulting molten material at a temperature lower than 3,000° C., the resulting molten material starts to solidify.

### Example 2

A method for preparing zirconium boride through electric smelting was performed the same as Example 1, except that in Example 2, 50 parts by weight of a natural baddeleyite with an amount of ZrO₂ plus HfO₂ of greater than 99%, 30 parts by weight of boric anhydride, and 27 parts by weight of a graphite powder were used.

In some embodiments of the present disclosure, under a condition that a material is in a molten state, the material is red, and as the temperature of the material decreases, the colour of the material becomes lighter, especially under a condition that the material is naturally cooled to not greater than 200° C., the colour of the material becomes light gray with a metallic luster; and under a condition that a resulting molten material at a temperature lower than 3,000° C., the resulting molten material starts to solidify.

### Example 3

A method for preparing zirconium boride through electric smelting was performed the same as in Example 1, except that in Example 3, 50 parts by weight of a chemical zirconium with an amount of ZrO₂ plus HfO₂ of greater than 99%, 32 parts by weight of boric anhydride, and 28 parts by weight of a petroleum coke powder were used.

In some embodiments of the present disclosure, under a condition that a material is in a molten state, the material is red, and as the temperature of the material decreases, the colour of the material becomes lighter, especially under a condition that the material is naturally cooled to not greater than 200° C., the colour of the material becomes light gray with a metallic luster; and under a condition that a resulting molten material at a temperature lower than 3,000° C., the resulting molten material starts to solidify.

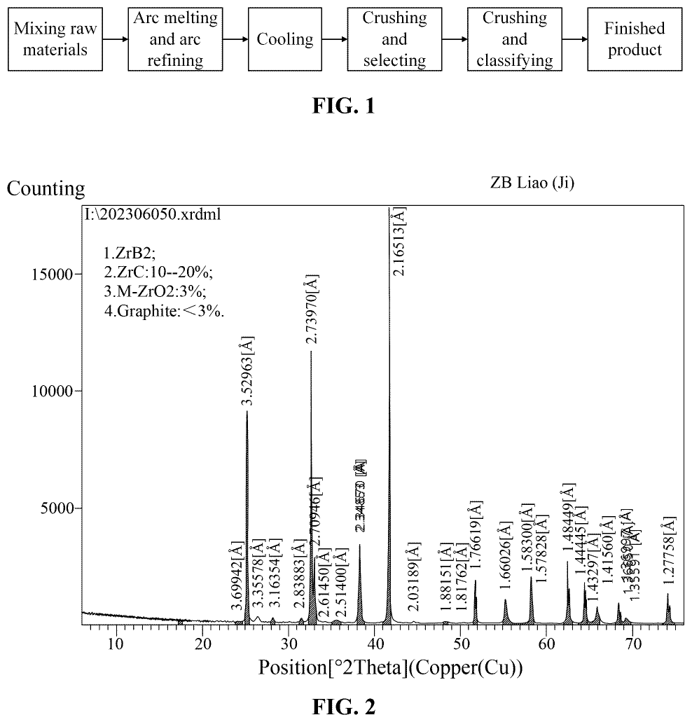

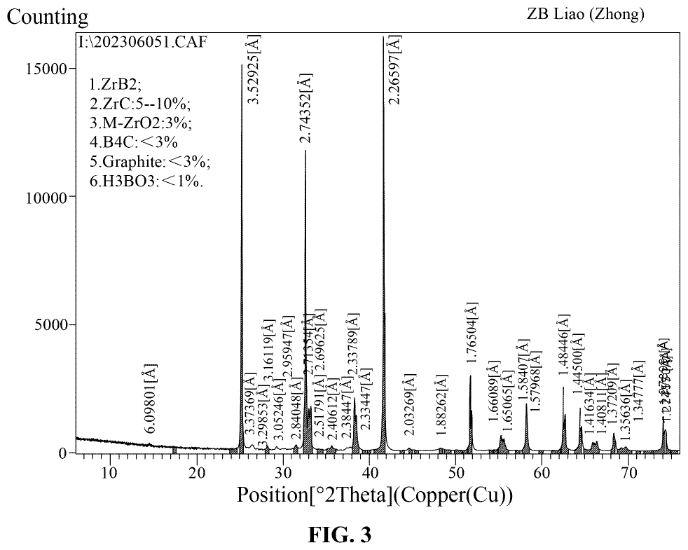

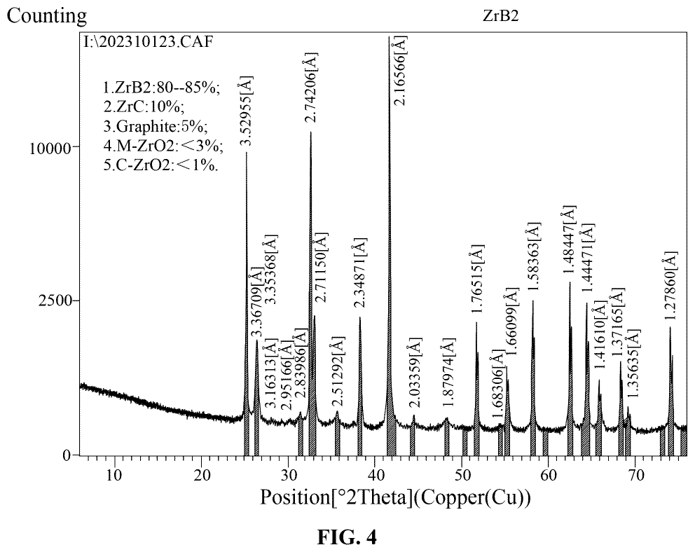

XRD was performed for the zirconium boride prepared in Examples 1-3, and the results are shown in FIG. 2 to FIG. 4. FIG. 2 shows an XRD crystalline phase diagram of the zirconium boride prepared in Example 1, FIG. 3 shows an XRD crystalline phase diagram of the zirconium boride prepared in Example 2, and FIG. 4 shows an XRD crystalline phase diagram of the zirconium boride prepared in Example 3.

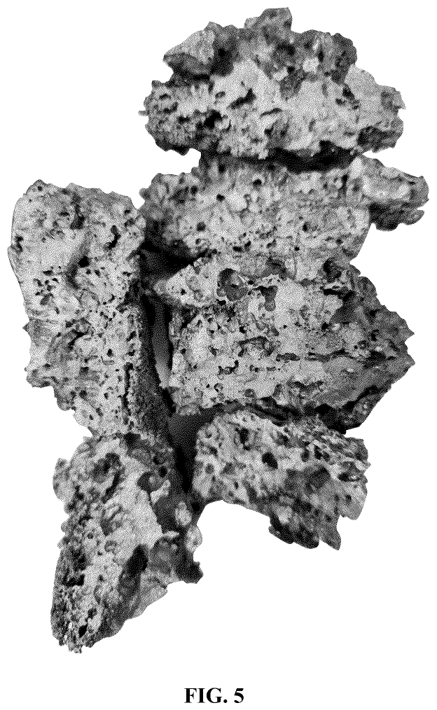

FIG. 5 shows a photograph of the zirconium boride prepared in Example 1.

The description above is only the preferred embodiments of the present disclosure. It should be noted that several improvements and modifications may also be made by those skilled in the art without departing from the principle of the present disclosure, and these improvements and modifications should also be considered within the scope of the present disclosure.

What is claimed is:

1. A method for preparing zirconium boride through electric smelting, comprising the following steps:
step 1: mixing a zirconium source, boric anhydride, and a carbon source in a parts-by-weight ratio of 50:28-32:24-28 to obtain a furnace charge;
step 2: conducting a smelting by feeding the furnace charge into a three-phase electric arc furnace and melting, subjecting a resulting material to refinement, heat preservation, and homogenization in sequence, and then repeating these processes a plurality of times until the three-phase electric arc furnace is full;
step 3: heat preserving a resulting product for 1 hour to 2 hours after the smelting, and turning off the three-phase electric arc furnace; after the three-phase electric arc furnace is turned off for 12 hours, removing a resulting furnace shell and natural cooling a resulting melt; and under a condition that the resulting melt falls to not greater than 100° C., crushing the resulting melt, selecting and removing a material skin;
step 4: crushing a resulting selected material to a particle size of greater than 0 and not greater than 4 meshes and selecting again, and removing a loose lump and collecting a dense lumpy material; and
step 5: crushing the dense lumpy material obtained in step 4 and removing iron, and then testing to qualify as a finished product.

2. The method for preparing the zirconium boride through the electric smelting of claim 1, wherein in step 1, the zirconium source is any one selected from the group consisting of a monoclinic zirconium dioxide, a desilicated zirconium, a natural baddeleyite, and a chemical zirconium; and an amount of ZrO₂ plus HfO₂ in the zirconium source is greater than 99%.

3. The method for preparing the zirconium boride through the electric smelting of claim 1, wherein in step 1, the carbon source is any one selected from the group consisting of carbon black, a graphite powder, and a petroleum coke powder.

4. The method for preparing the zirconium boride through the electric smelting of claim 1, wherein in step 2, the three-phase electric arc furnace is selected from the group consisting of a stationary electric arc furnace and a tilted electric arc furnace.

5. The method for preparing the zirconium boride through the electric smelting of claim 1, wherein in step 2, the melting and the refinement are independently performed at a voltage of 120 volts to 250 volts and a current of 6,000 amperes to 15,000 amperes.

6. The method for preparing the zirconium boride through the electric smelting of claim 5, wherein in step 2, the melting and the refinement are independently performed at the voltage of 220 volts and the current of 8,000 amperes to 12,000 amperes.

7. The method for preparing the zirconium boride through the electric smelting of claim 1, wherein in step 2, a ratio of a time for the melting to a time for the refinement is 1:2.

8. The method for preparing the zirconium boride through the electric smelting of claim 1, wherein in step 2, the melting and the refinement are independently performed at a temperature of 3,000° C. to 3,300° C.
